(19) United States
(12) Patent Application Publication
(10) Pub. No.: US 2018/0345351 A1
(43) Pub. Date: Dec. 6, 2018

(54) Punch Assembly with Quick Release Removable Head

(71) Applicants: Dale Natoli, Defiance, MO (US); James Boyer, St. Louis, MO (US)

(72) Inventors: Dale Natoli, Defiance, MO (US); James Boyer, St. Louis, MO (US)

(21) Appl. No.: 15/835,723

(22) Filed: Dec. 8, 2017

Related U.S. Application Data
(60) Provisional application No. 62/512,354, filed on May 30, 2017.

(51) Int. Cl. B21D 37/04; B21D 28/34; B26D 7/26; B26F 1/14

(52) U.S. Cl. CPC B21D 37/04; B21D 28/34; B26F 1/06; B26F 1/14; B26D 7/2614

(57) ABSTRACT

A punch assembly having a head with an approximately flat top, an engagement projection and a groove; and a cylindrical punch having a tip end and a head engaging end, wherein the head engaging end has mounted thereon opposing pivoting arms having projections; the arms held by pivot pins and a compression spring mounted between the arms in a closed position; wherein the engagement projection of the head is pressed between the arms and snaps into place; and the projections are securely engaged in the groove.

### CROSS-REFERENCE TO RELATED APPLICATIONS

This application claims the benefit of provisional patent application 62/512,354 filed on May 30, 2017, which is hereby incorporated by reference.

### STATEMENT REGARDING FEDERALLY SPONSORED RESEARCH

Not Applicable.

### APPENDIX

Not Applicable.

### BACKGROUND OF THE INVENTION

### Field of the Invention

The present invention relates to compression punches, and more particularly to a compression punch assembly with a replaceable head that has a quick release mechanism.

### Related Art

This invention relates generally to compaction tooling components, and more particularly to a compaction tool, such as a punch. Compaction systems that utilize pistons or plungers as punches to compress solids, fluids, or the like, are employed in various industries, such as industrial, oil and gas, core drilling and mining, compaction tooling and tableting equipment for the pharmaceutical industry, and power jet markets. During the compaction process, however, the application of significant compressive forces results in wear to the tips and heads of the punches. This force, associated friction and the nature of the materials being compacted, causes a high level of wear on the compaction tooling, resulting in the frequent need to change out and rework such tooling. US patent publication 2016/0185064 discloses a punch assembly with a replaceable ceramic head. It has been found that ceramic parts in punches do not function well. U.S. Pat. No. 8,657,594 discloses a punch assembly with a replaceable tip that, while not requiring a tool to replace the tip, does require the manipulation of several parts to replace the tip.

It has been found that different compositions for compaction respond differently to punch head size and shape. Some provide improved tables with larger heads that give longer compression times. However, with other compositions, the opposite is true. There is a need for a compression tool with a quick release device to change the punch head quickly and easily. None of the prior art suggests the claimed invention.

The present invention provides a punch assembly with a replaceable head that is quick release, and snaps on and is easily removed, allowing the replacement to take place quickly and efficiently. There is no need to remove screws or pins to release the head.

Examples of additional known prior art devices are described in U.S. Pat. No. 8,312,612 and U.S. Pat. No. 5,079,983, which are hereby incorporated by reference.

### SUMMARY OF THE INVENTION

The present invention relates to a punch assembly with a snap on head that is easily and quickly removed. The punch assembly comprises a head having an approximately flat top, an engagement projection and a groove; and a cylindrical punch body having a tip end and a head engaging end. The head engaging end has mounted thereon opposing pivoting arms having pivot points, wherein above the pivot points are opposing projections and below the pivot points are release ends. The arms are held in a closed position by pivot pins and a compression spring mounted between the release ends. The engagement projection of the head is pressed between the projections and snaps into place with the projections releasably held in the groove. To release the head, the release ends are compressed toward each other, pivoting the projections apart to an open position, thereby releasing the head.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is the punch assembly of the present invention, disassembled.

FIG. 2 is the punch assembly assembled.

FIG. 3 is a cutaway drawing of the engagement mechanism of the punch assembly in the closed position.

FIG. 4 is a cutaway drawing of the engagement mechanism of the punch assembly in the opened position.

FIG. 5 is a second embodiment of the punch assembly, disassembled.

FIG. 6 is a third embodiment of the punch assembly, disassembled.

### DETAILED DESCRIPTION OF THE PREFERRED EMBODIMENTS

The following description of the preferred embodiment(s) is merely exemplary in nature and is in no way intended to limit the invention, its application, or uses.

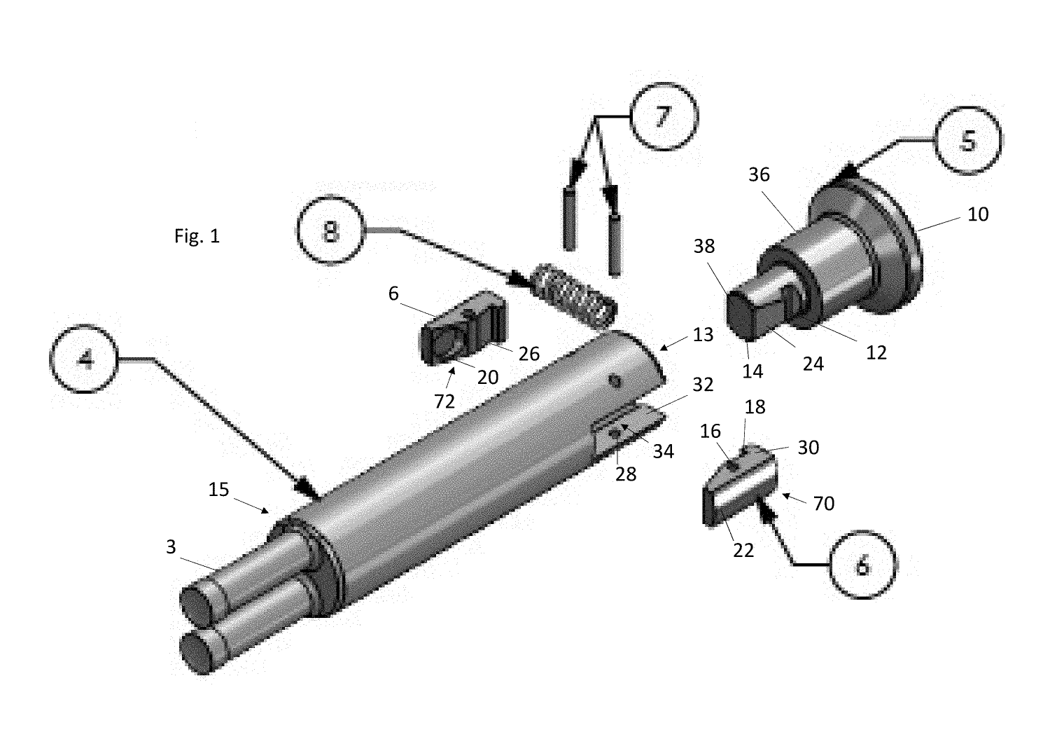

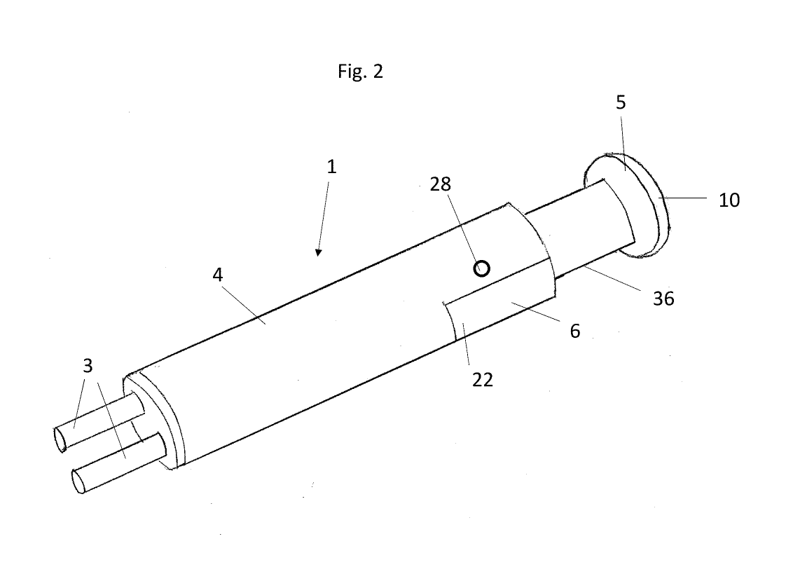

FIGS. 1-6 illustrate an embodiment of the punch assembly of the present invention. Punch assembly 1 is shown in FIG. 1 disassembled. The head 5 has an approximately flat top of the head 10 which is typically impacted when the punch assembly is being used for compaction. The cylindrical head extension 36 extends from the top of the head to the engagement projection 38. On the engagement projection 38 are projection engagement grooves 12 which are symmetrically placed on opposite sides of the engagement projection 38. Alternatively, the engagement grooves are one groove that encircles the entire projection 38. Between the bottom of the head 14 and the engagement groove is the sloping insertion surface 24 that facilitates the mounting of the head on the body.

The punch body 4 is preferably cylindrical. At one end of the punch body 4 is the tip engaging end 15, having a tip 3, which impacts the material to be compacted. At the other end of the punch is the head engaging end 13 having a pivot latch opening 34. The opening transects the punch body 4, creating arm engagement surfaces 32. Pin engagement openings 28 are placed off-center of the longitudinal axis of the cylindrical punch body, opposite each other on the engagement surfaces and transect the punch body 4.

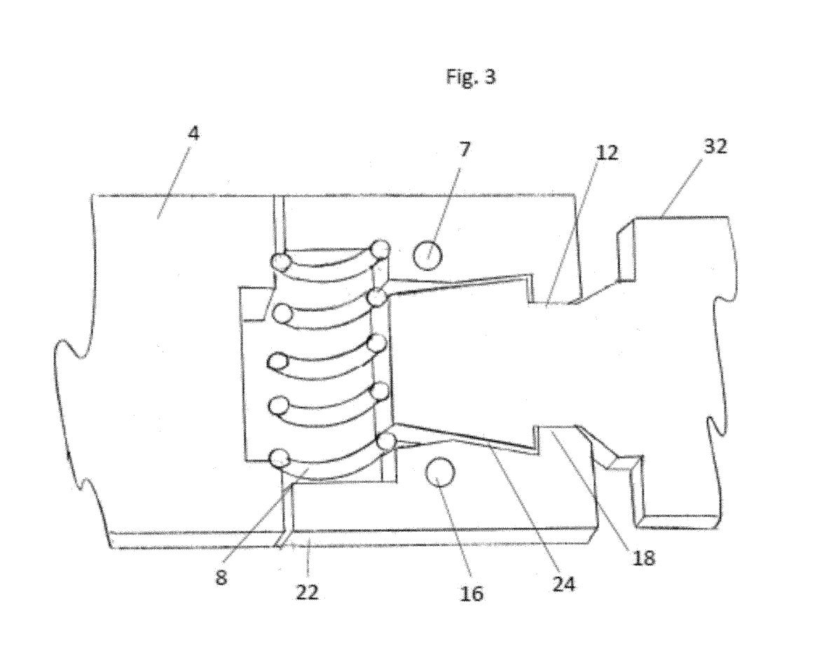

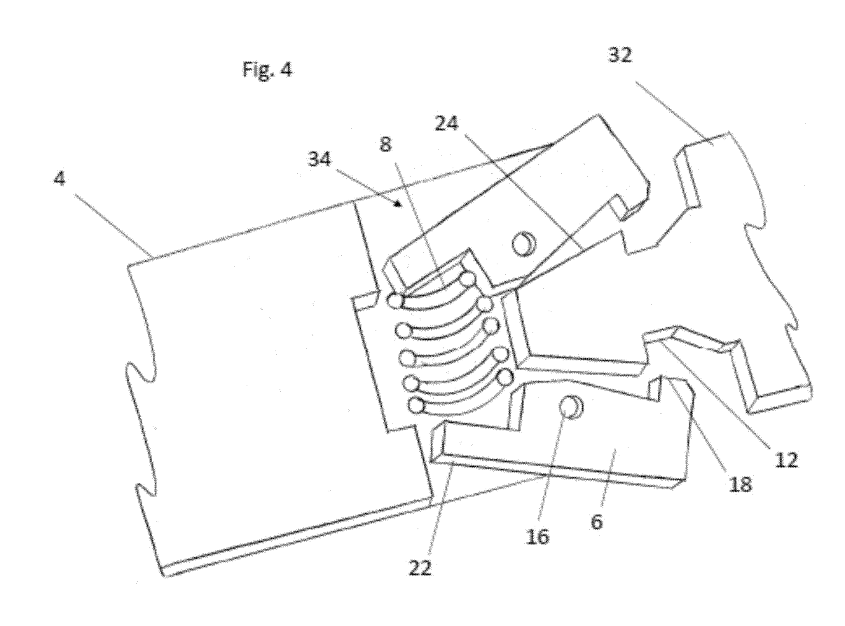

A pivot latch assembly 11 comprises opposing arms 6, pins 7 and a compression spring 8. Opposing arms 6 of the pivot latch have two approximately parallel side surfaces 30, a pivot point opening 16 and, on the exterior surface 70, a release end 22. The pivot point opening 16 is approximately perpendicular to the side surfaces 30. On the interior surface 72 of the arms of the pivot latch 6 is a spring engagement surface 20, a sloping engagement surface 26 and a projection 18. The projections 18 are above the pivot points and the release ends 22 are below the pivot points. As shown in FIG. 3, the arms of the pivot latch 6 are in the closed position, and the compression spring 8 nests between the two arms in the spring engagement surfaces 20. The two arms of the pivot latch 6 face each other and are held in the closed position by the pins 7 which pass through the pin engagement openings 28 and the pivot points 16, and the push of the compression spring 8. The projections 18 engage releasably with the projection engagement grooves 12 and hold the head 5 to the punch body 4 creating the punch assembly 1. As shown in FIG. 4, the arms 6 pivot out by pressing on the release ends 22 causing the two arms of the pivot latch to pivot, and the projections 18 to move from a closed position to an open position, thereby releasing the head 5.

When the head 5 is replaced with another head, the head extension 36 is pressed downward into the pivot latch opening 34. The sloping insertion surface 24 pushes against the projection 18, which is held in a closed position by compression spring 8 pushing against the spring engagement surface 20. As the head proceeds downward, the projection 18 snaps into the projection engagement groove 12, and the head 5 is mounted on the punch body 4, creating the punch assembly 1. The sloping insertion surface 24 approximately rests against the sloping engagement surface 26.

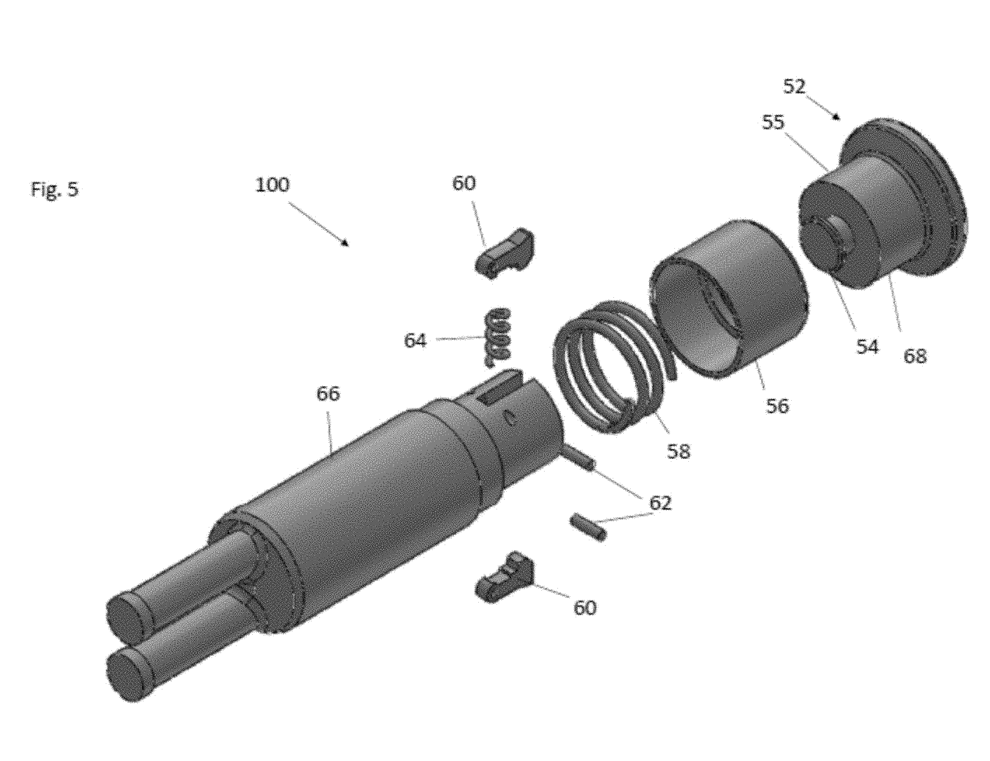

In a second embodiment, as shown in FIG. 5, a punch assembly 100 is made of a head 52 and a punch 66. The head 52 has an extension 68, an engagement projection 54, and a circular groove 55. The cylindrical punch 66 has a tip end and a head engaging end. Mounted in the head engaging end are opposing arms 60 of the pivot latch held in a closed position by tension between the pins 62 and compression spring 64. The head 52 is mounted on the head engaging end by mounting an outer compression spring 58 over the engaging end, sliding a sleeve 56 over the outer compression spring 58, then pressing the head 52 through the outer compression spring and the sleeve, and engaging it with the opposing arms 60 which pivot to then snap into place over the circular projection 54 and into the circular groove 55. The head is held in upward tension by the outer compression spring mounted between the punch and the head. This second embodiment has the advantage that the circular groove does not have a need of a particular alignment of the head with the transverse opening between the arms in order to snap it into place.

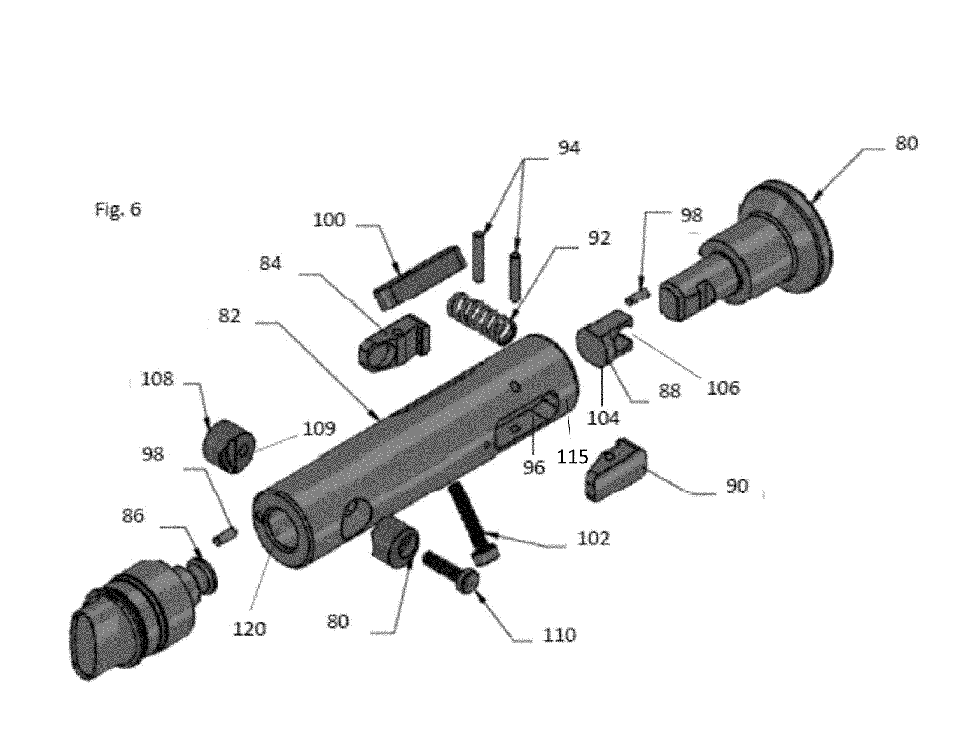

In a third embodiment shown in FIG. 6, the punch assembly 81 has a head 80, a punch body 82, a pivot latch assembly 84 and a removable tip 86. The pivot latch assembly has opposing arms 90, held in place by pivot pins 94. A compression spring retention holder 88 having a spring retention holder base 104 and a spring retention holder opening 106 is mounted between the two opposing arms. The opening 106 is sized to engage with a compression spring 92 which is inserted through the opening and provides tension to the opposing arms.

The pivot latch assembly 84 is inserted into the enclosed pivot latch opening 96 and is held in place by the pivot pins 94 which are inserted through openings in the punch body and the opposing arms, as described above. The enclosed pivot latch opening 96 has a closure piece 115 that creates the enclosed opening 96 which serves to securely hold the pivot latch assembly by providing an enclosure for the opposing arms. The latch assembly 84, when mounted in the punch body is biased closed. The spring retention holder base 104 is sized to fit and engage with the enclosed pivot latch opening 96 to stabilize and secure the compression spring 92. When the removable head is mounted on the punch body and is held in place by the pivot latch assembly, it can be aligned using an alignment pin 98. Optionally, a key 100 can be mounted on the side of the punch body using a key mounting screw 102. The key can be used to facilitate the removal of the head 80 by pressing it against the opposing arms 90.

The removable tip 86 can be inserted into the removable tip insertion opening 120 and held in place with the lock 108 which has two parts held in place with the insert lock set screw 110. The two lock parts have an insert lock grip surface 109 which grips the removable tip 86 when the lock set screw is tightened and releases when the lock set screw is loosened.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A punch assembly comprising:
a head having an approximately flat top, an engagement projection and a groove; and
a cylindrical punch body having a tip end and a head engaging end; and
a latch assembly on the head engaging having an opened position and a closed position;
wherein the groove is positioned between the flat top and the engagement projection;
wherein the latch assembly is mounted on the head engaging end;
wherein in the closed position the latch assembly is releasably engaged with the groove; and
wherein in the opened position the latch assembly is released from the groove.

2. The punch assembly of claim 1, wherein the latch assembly has opposing pivot arms having pivot points, an exterior surface and an interior surface; a compression spring; and pivot pins.

3. The punch assembly of claim 2, wherein on the interior surface are opposing projections.

4. The punch assembly of claim 3, wherein the opposing projections are located above the pivot points and the compression spring is mounted on the interior surface between the opposing pivot arms and below the pivot points.

5. The punch assembly of claim 4, wherein on the exterior surface are release ends located below the pivot points and opposite the compression spring,

6. The punch assembly of claim 5, wherein the pivot pins are mounted through the pivot points and held in the punch body; and
wherein the opposing pivot arms are releasably held in the closed position by the compression spring.

7. The punch assembly of claim 6, wherein the engagement projection of the head is inserted between the projections of the opposing pivot arms and snaps releasably into the closed position; and
wherein the projections are securely engaged in the groove.

8. The punch assembly of claim 7, wherein the latch assembly is biased in the closed position.

9. A punch assembly comprising:
a head having an approximately flat top, an engagement projection and a groove; and
a cylindrical punch body having a tip end and a head engaging end; and
a pivot latch assembly having an opened position and a closed position;
wherein the groove is positioned between the flat top and the engagement projection;
wherein the pivot latch assembly is mounted on the head engaging end;
wherein the pivot latch assembly is mounted in a pivot latch opening on the head engaging end;
wherein the pivot latch assembly has opposing pivot arms having pivot points, an exterior surface and an interior surface; a compression spring; and pivot pins;
wherein on the interior surface are opposing projections;
wherein the opposing projections are above the pivot points and the compression spring is mounted on the interior surface between the opposing pivot arms and below the pivot points;
wherein on the exterior surface are release ends located below the pivot points and opposite the compression spring;
wherein the pivot pins are mounted through the pivot points and held in the punch body;
wherein the opposing pivot arms are held by the compression spring;
wherein the engagement projection of the head is inserted between the projections of the opposing pivot arms and snaps releasably into the closed position; and
wherein the projections are securely engaged in the groove.

10. The punch assembly of claim 9,
wherein when the release ends are pressed toward the compression spring, the opposing pivot arms pivot to an opened position, thereby releasing the head.

11. The punch assembly of claim 10,
wherein the groove is a circular groove.

12. The punch assembly of claim 10, wherein the latch assembly is biased in the closed position.

13. The punch assembly of claim 12, wherein a spring retention holder is mounted in the pivot latch opening.

14. The punch assembly of claim 13, wherein the spring retention holder stabilizes the compression spring.

15. The punch assembly of claim 14, wherein the compression spring is inserted through a spring retention holder opening.

16. A punch assembly comprising:
a head having an approximately flat top, an engagement projection and a groove; and
a cylindrical punch body having a tip end and a head engaging end; and
a latch assembly having an opened position and a closed position;
wherein the groove is positioned between the flat top and the engagement projection;
wherein the latch assembly is mounted on the head engaging end in a pivot latch opening;
wherein the latch assembly has opposing pivot arms having pivot points, an exterior surface and an interior surface; a compression spring; and pivot pins;
wherein a spring retention holder is mounted in the pivot latch opening between the pivot arms;
wherein on the interior surface of the latch assembly are opposing projections;
wherein the opposing projections are located above the pivot points and the compression spring is mounted between the opposing pivot arms, and inserted through the spring retention holder below the pivot points;
wherein on the exterior surface are release ends located below the pivot points and opposite the compression spring;
wherein the pivot pins are mounted through the pivot points and held in the punch body;
wherein the opposing pivot arms are held in tension by the compression spring;
wherein the engagement projection of the head is inserted between the projections of the opposing pivot arms and snaps releasably into the closed position; and
wherein the projections are securely engaged in the groove.

17. The punch assembly of claim 16,
wherein when the release ends are pressed toward the compression spring, the opposing pivot arms pivot to an open position, thereby releasing the head.

18. The punch assembly of claim 17,
wherein the groove is a circular groove.

19. The punch assembly of claim 17, wherein the latch assembly is biased in the closed position.

20. The punch assembly of claim 9, wherein the pivot latch opening is enclosed.
